(19) United States
(12) Patent Application Publication
(10) Pub. No.: US 2026/0095340 A1
(43) Pub. Date: Apr. 2, 2026

(54) SYSTEMS AND METHODS FOR AUTOMATICALLY CONFIGURING CONFERENCE DEVICES BASED ON DEVICE PROXIMITY

(71) Applicant: RingCentral, Inc., Belmont, CA (US)

(72) Inventors: Venkatesh Iyer, San Francisco, CA (US); Anand Gupta, Round Rock, TX (US)

(73) Assignee: RingCentral, Inc., Belmont, CA (US)

(21) Appl. No.: 18/903,071

(22) Filed: Oct. 1, 2024

(51) Int. Cl. H04L 12/18; G01S 1/04; H04W 4/80

(52) U.S. Cl. CPC H04L 12/1818; G01S 1/047; H04L 12/1822; H04W 4/80

(57) ABSTRACT

Systems, devices, and methods for preemptively resolving audio and video issues when multiple devices join the same conference from the same room. The systems, devices, and methods include automatically configuring conference features of the devices based on detected proximity with other devices participating in the same conference. A first device receives identifiers indicating a conference that a second device has joined from a particular location. The first device also receives a request to join the conference with the first device at the particular location, and configures the conference features in response to the request to join the conference that the second device has joined from the same particular location. Configuring the conference features includes modifying a conference feature on the first device to not conflict with the conference feature on the second device.

### TECHNICAL FIELD

The present disclosure relates to the field of telecommunications and audio/video communications.

### BACKGROUND

Conference disruptions or distractions may occur when multiple devices in the same physical room join the conference with microphones and speakers enabled and/or audio and video feeds enabled. For instance, echoes may be introduced when the audio or speaker output from one device in the room is picked up by the microphone of another device in the room and is fed back into the conference audio stream. Similarly, a device in the room that is connected to the conference may share content that includes audio. The audio is played back on that device's speakers as well as speakers of a primary conference device or other client devices that are in the same room and that have joined the conference. The content audio may create feedback or echoes, or may be unsynchronized when played from the different devices speakers with different delays. Conference video feeds may also create disruptions or distractions. For instance, the video feed playing on a client device that presents other live users that are physically present in the same room as the user of the client device may create a distraction when the video feed is delayed relative to the movements and speech of the other live users in the room. Accordingly, there is a need to create a seamless conference experience without disruptions or distractions by proper configuration of client devices that are next to one another and that join the same conference.

### BRIEF DESCRIPTION OF THE DRAWINGS

FIG. 1 illustrates an example of automatically configuring conference features on a device based on device proximity in accordance with some embodiments presented herein.

FIG. 2 illustrates an example of configuring conference features from a graphical user interface in accordance with some embodiments presented herein.

FIG. 3 presents a process for automatically configuring conference devices based on device proximity in accordance with some embodiments presented herein.

FIG. 4 illustrates an example of using supplemental conference data to automatically configure conference devices in accordance with some embodiments presented herein.

FIG. 5 presents a process for automatically configuring conference features to resolve issued created when sharing content with multiple devices in the same room that are connected to the same conference in accordance with some embodiments presented herein.

FIG. 6 illustrates an example of automatically configuring a customized conference presentation for a client device in accordance with some embodiments presented herein.

FIG. 7 illustrates an example of performing the automatic configuration of conference features based on proximity detection that is conducted without beacons in accordance with some embodiments presented herein.

### DETAILED DESCRIPTION OF PREFERRED EMBODIMENTS

This disclosure arises from the realization that conference participants may join a conference via multiple devices or that different conference participants in the same physical room may join the conference using their separate devices rather than one shared device. The physical proximity of two or more devices that are connected to the same conference may create audio and video synchronization issues that cannot be corrected with noise cancellation, noise filtering, or artificial intelligence synchronization techniques, and may create various disruptions or distractions throughout the conference.

The current disclosure provides a technological solution for a technological problem in the fields of telecommunications and audio and/or video communications. The technological solution involves detecting two or more devices that are in physical proximity with one another or that are in the same physical room or space and that connect to the same conference. The technological solution further involves providing one or more of the detected devices with configuration options that prevent echoes, output delays, and other audio and/or video synchronization issues from disrupting or creating distractions in the conference. In some example embodiments, providing the configuration options includes automatically enabling or disabling audio and video streams of the device based on configurations and locations of other devices connected to the same conference, automatically adjusting speaker volume levels of the device, and/or automatically enabling alternative modalities or supplemental interfaces for a conference that remove delayed video feeds for physically present participants or other distracting audio and/or video. In some example embodiments, providing the configuration options includes presenting an interface with selectable configuration options and notifications prompting the user to enable or disable the selectable configuration options for a seamless, disruption-free, and/or distraction-free conference.

The technical solution preemptively detects and resolves synchronization issues before they occur. In particular, the technical solution avoids the disruptions that may be caused by conference participants attempting to manually diagnose which client device is creating a distraction, manually notifying the user of the client device of that distraction, and waiting for the user to locate and manually adjust settings for resolving the distraction. Moreover, the technical solution allows a conference participant to join a conference without having to disable all conference features or guess the features that may create disruptions, distractions, or synchronization issues if other conference participants are in the same room and/or the other conference participants have certain features enabled that may interfere with features that the conference participant wants to enable on their own device.

In some example embodiments, the technological solution is implemented within a conference system that hosts, establishes, and/or otherwise provides audio and video conferences and/or communications over a data network for two or more client devices. In some example embodiments, the technological solution is implemented on the devices that use the conference system to establish the audio and video conferences and/or communications and to communicate with one another. For instance, the technological solution may be implemented as part of a conferencing application that the devices use to access the conference services from the conference system, or may be implemented in the firmware, controller, or other software of conference devices or appliances that the conference system provides for shared access to a conference.

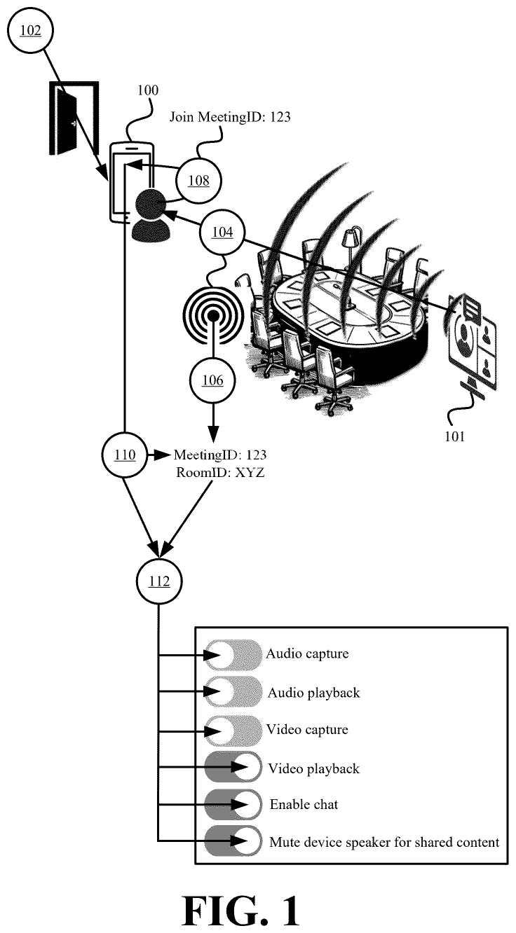

FIG. 1 illustrates an example of automatically configuring conference features on a device based on device proximity in accordance with some embodiments presented herein. A user enters (at 102) a physical room with client device 100. Client device 100 may include a smartphone, connected wearable device, tablet, laptop, or other portable device with wired or wireless network connectivity, a screen to display video content, a speaker to play audio content, a microphone to capture audio, camera to capture video, and/or processor, memory, storage, and other hardware resources for connecting to and participating in different conferences.

Client device 100 receives (at 104) one or more beacons as client device 100 enters into range of the short-range wireless radio technology that conference device 101 uses to broadcast or otherwise disseminate the one or more beacons. In some example embodiments, Bluetooth Low Energy (LE) is used to disseminate the one or more beacons a controlled distance (e.g., 5 to 100 meters) from conference device 101.

Conference device 101 may include a set-top device or other shared device that remains in a conference room for different users to use and that connects multiple simultaneous users to a conference for hybrid (e.g., a combination of physically present conference participants and remotely connected conference participants) and virtual (e.g., conference participants joining the conference from different physical locations) meetings. Conference device 101 may also include a user device such as a laptop, tablet, or other device that does not remain in the conference room.

Conference device 101 may continually broadcast (e.g., every 5 seconds) the beacons. In some example embodiments, client device 100 receives (at 104) the one or more beacons when a conference application is open and running in a foreground of client device 100. In some other example embodiments, client device 100 receives (at 104) the one or more beacons as soon as client device 100 enters in the signaling range of conference device 101 by actively listening for the beacons whenever client device 100 is powered on or operational. In still some other example embodiments, client device 100 receives (at 104) the one or more beacons when the user attempts to join a conference using client device 100.

Client device 100 may receive (at 104) beacons from different devices (e.g., different conference devices and/or client devices) when client device 100 is in signaling range of the different devices. For instance, client device 100 may be located in a first conference room and receive (at 104) beacons from a first conference device that is located in the first conference room and from a second conference device that is located in a nearby second conference room or another client device that is also located in the first conference room.

Client device 100 extracts (at 106) meeting data from the one or more beacons. The meeting data may include a first identifier that identifies the physical room in which conference device 101 is located (e.g., a name of a conference room or a meeting room) and/or a second identifier for the conference or meeting that conference device 101 is currently connected to or that is starting next. In some example embodiments, each beacon may contain other meeting data such as the list of invited participants, other devices that joined or connected to the conference identified by the second identifier, and/or status of the other devices. The status of the other devices may include the conference features that are enabled or disabled on the other devices. For instance, the status may indicate which of the other devices have the conference audio stream enabled or disabled. In some example embodiments, part of the meeting data may be obtained from the one or more beacons and another part of the meeting data may be obtained from a server or other conferencing system host device that connects the audio and/or video streams from the different devices of the same conference and/or that provides the audio and video multiplexing and/or compositing for the conference.

Client device 100 receives (at 108) a request to join a conference that is identified with a particular meeting identifier. For instance, a user may open a conferencing application on client device 100 and enter the particular meeting identifier or the user may select a link that opens the conferencing application and automatically joins the conference with the particular meeting identifier.

Client device 100 determines (at 110) that the particular meeting identifier from the join request matches a meeting identifier (i.e., the first identifier) that is extracted (at 106) from a received (at 104) beacon. Based on the match, client device 100 may set its location as the location of the conference room identified in the beacon with the matching meeting identifier. In some example embodiments, client device 100 may prompt the user to select between different conference rooms or locations that are identified in the received (at 104) beacons, and may set its location as the location of the conference identified in the beacon with the matching meeting identifier in response to the user selecting that conference room or location.

Client device 100 configures (at 112) one or more conference features in response to the location of client device 100 matching the location of the conference room that is associated with the meeting identifier of the conference in the received (at 108) join request. Configuring (at 112) the one or more conference features includes enabling and/or disabling audio and video streams of the conference on client device 100 in order not to interfere with audio and video streams of conference device 101. For instance, conference device 101 may be a device that multiple users use to participate in the conference and to listen to the audio from other remote conference participants. Client device 100 disables the audio stream to avoid redundant and/or unsynchronized playback of the audio stream that may interfere with the audio playback by conference device 101 and/or create an echo. Disabling the audio stream may include invoking the functionality for joining the conference without computer audio or automatically muting the client device 100 microphone.

In some example embodiments, configuring (at 112) the one or more conference features may include automatically setting the desired parameters for the one or more conference features without user input. In some other example embodiments, configuring (at 112) the one or more conference features may include presenting an interface with recommended values for configuring (at 112) the one or more conference features to the user of client device 100 for the user to implement or disregard.

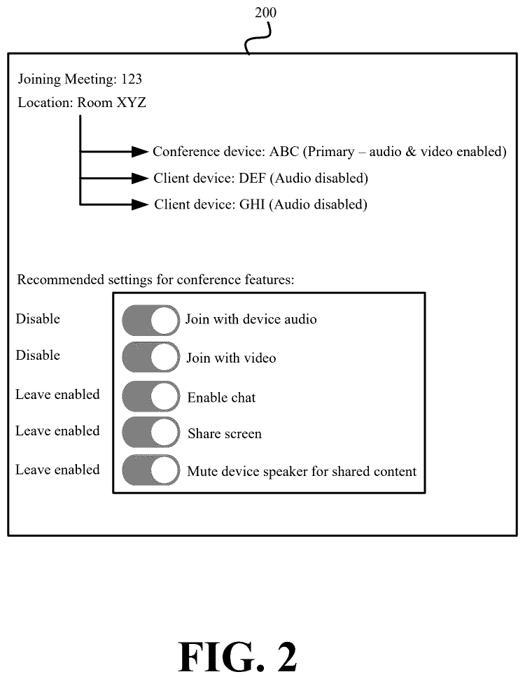

FIG. 2 illustrates an example of configuring conference features from a graphical user interface 200 in accordance with some embodiments presented herein. Interface 200 may confirm that client device 100 is physically located in a meeting room with one or more other devices and is connected to or will be joining the same conference as the one or more other devices. Interface 200 may present a prompt with configuration settings for the one or more conference features that avoid the audio and/or video synchronization issues and/or other disruptions or distractions from occurring due to microphones picking up played back conference audio from another speaker and/or cameras capturing video on other displays or playing video feeds of live users in the same room with a delay relative to their actions in the room.

In some example embodiments, client device 100 may present interface 200 prior to client device 100 joining or entering the conference. In some example embodiments, client device 100 may present interface 200 with the recommended settings for the conference features, and the user may have the option to revert to default or previous settings.

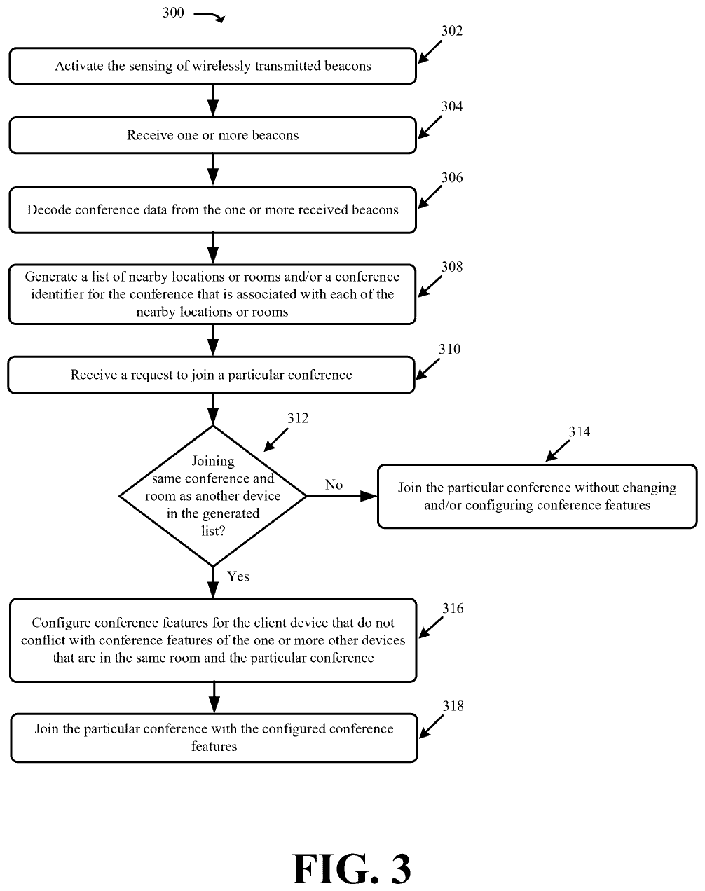

FIG. 3 presents a process 300 for automatically configuring conference devices based on device proximity in accordance with some embodiments presented herein. Process 300 may be implemented by any of the devices that join or connect to a conference. The device implementing process 300 includes processor, memory, storage, network, and/or other hardware resources for joining and/or connecting to a conference that is remotely hosted or that includes remote participants and for sending and receiving the conference audio and/or video. The device may further include one or more of a Bluetooth radio or transceiver, microphone, speaker, camera, and display.

Process 300 includes activating (at 302) the sensing of wirelessly transmitted beacons. The beacon sensing may be activated (at 302) while the device is powered on, in a sleep state, or in an inactive or lock state. The beacon sensing may also be activated (at 302) in response to a user action or input. For instance, opening a conferencing application and running the conferencing application in the foreground or background may activate (at 302) the beacon sensing. Alternatively, user input to join a conference may activate (at 302) the beacon sensing. Activating (at 302) the beacon sensing may include powering on a Bluetooth radio or transceiver of the device and/or using the Bluetooth radio or transceiver to listen for beacons transmitted from other nearby devices.

Process 300 includes receiving (at 304) one or more beacons. The one or more beacons may be transmitted and received according to Bluetooth LE specifications or specifications of another short-range wireless protocol or technology (e.g., Ultra-Wideband (UWB)).

Process 300 includes decoding (at 306) conference data from the one or more received (at 304) beacons. Each beacon encodes at least a first identifier for a location or meeting room associated with the transmitting device. Each beacon may further encode a second identifier for a meeting or conference that has started or is scheduled to start through the transmitting device. The one or more beacons may encode other information such as the devices that have already connected to the meeting and/or the status of the connected devices. The status may indicate the device type, conference feature settings (e.g., whether the devices have enabled or disable audio and video playback), device location, and/or other information that may affect the configuration of conference features on the receiving device.

Process 300 includes generating (at 308) a list of nearby locations or rooms and/or a conference identifier for the conference that is associated with each of the nearby locations or rooms from decoding (at 306) the one or more received (at 304) beacons. The list may be periodically updated to add new conference identifier, locations, or rooms based on newly received (at 304) beacons containing the identifiers, and to remove conference identifiers, locations, or rooms associated with stale beacons that have not been refreshed for a period of time or that were received more than a threshold amount of time in the past.

Process 300 includes receiving (at 310) a request to join a particular conference. The request may be initiated in response to receiving an invitation from a host or another participant of the particular conference, selecting a link to join the particular conference, and/or a user otherwise specifying the particular conference via a selection in the conferencing application or entering a Uniform Resource Locator (URL) or other identifier in the conferencing application or a web browser.

Process 300 includes determining (at 312) whether the client device receiving (at 310) the request to join is in the same location or room as another device that sends one of the received (at 304) beacons and that the other device is also participating in the same particular conference as the client device. In some example embodiments, the determination (at 312) is made by matching the conference identifier from the join request to a conference identifier within the generated (at 308) list or a conference identifier that was recently decoded (at 306) from a beacon broadcast or otherwise transmitted from the other device. In some other example embodiments, the determination (at 312) includes presenting a prompt on the client device that asks the associated user whether they are in the same location or room and joining the same conference as another device in the generated (at 308) list.

Process 300 includes joining (at 314) the particular conference without changing and/or configuring conference features in response to determining (at 312—No) that the client device receiving (at 310) the request to join is not in the same location or room and conference as another device that sends one of the received (at 304) beacons. When the devices are not in the same location or room and in the same conference, then there is no potential for echoes or unsynchronized audio and video being caused by the microphone of one device feeding back the conference audio from the speaker of another device. Similarly, the potential for video synchronization issues and/or other disruptions or distractions from redundant recording and/or playback of audio or video are eliminated.

Process 300 includes configuring (at 316) conference features for the client device that do not conflict with conference features of the one or more other devices that are in the same room and the particular conference in response to determining (at 312—Yes) that the client device receiving (at 310) the request to join is in the same location or room as the one or more other devices that send one of the received (at 304) beacons. Configuring (at 316) the conference features includes enabling or disabling one or more features or settings for capturing or playing back the particular conference audio or video that could introduce echoes, feedback, delay, synchronization issues, and/or other conflicts that create disruptions or distractions in the particular conference audio or video playback.

The configurable conference features may include enabling or disabling the particular conference audio stream such that the configured client device does not record audio to send to other connected devices or does not playback audio captured from the other connected devices. The configurable conference features may include setting the volume at which the configured client device speaker plays back the conference audio and/or the audio of any content being presented as part of the particular conference or that is played on the client device without affecting or changing the volume of the application or tool being used to playback the content. The configurable conference features may include enabling or disabling the particular conference video stream to avoid redundant video streams on the client device and another device in the same room or distractions from viewing one or more of the users live in the room and with a delay in the video stream. The configurable conference features may include modifying the video stream so that shared or presented content is presented on the client device without video feeds of individual participants some of which may be physically present in the room with the user of the client device. Modifying the video stream may also include removing the video feeds from other participants that are in the same location or room as the client device.

The conference features may be automatically configured (at 316) by the conferencing application running on the client device. For instance, the client device or the conferencing application running on the client device may automatically enable or disable certain conference features before joining the particular conference.

Alternatively, configuring (at 316) the conference features may include determining the settings for the conference features that avoid the audio and/or video conflicts associated with the client device and the one or more other devices joining the same conference from the same location or room, and presenting the settings in an interface to a user of the client device. The user may manually adjust the conference features according to the presented settings or may select a button or other input on the interface to provide confirmation for the conferencing application to automatically configure the conference features with the presented settings.

Process 300 includes joining (at 318) the particular conference with the configured (at 316) conference features. Various conference features or functionality may be provided by the client device and other conference features or functionality may be provided by the one or more other devices in the same room in order to avoid conflicts that may disrupt or interfere with the particular conference.

In some embodiments, the client devices may receive supplemental conference data from the conferencing system host device. The conferencing system host device may operate from the “cloud” and provide the conferencing services for different conferences. For instance, the conference system host device may receive the connection or join requests from the different devices, may authenticate device access, may combine the separate audio and video streams from each connected device, and may generate a unified stream to distribute back to the devices.

The conferencing system host device may acquire the supplemental conference data as a result of providing the conferencing services and/or connecting the different devices to a conference. For instance, the conferencing system host device may track the client devices that have already connected to a particular conference, identifiers for the connected client devices, locations of the client devices, and/or conference features that are enabled or disabled on each of the client device. Accordingly, when a new client device attempts to join the particular conference by contacting the conferencing system host device with a join request or other message, the conferencing system host device may provide the new client device with the supplemental conference data, and the new client device may automatically configure its conference features based on the supplemental conference data and/or data that extracted from one or more beacons. The supplemental conference data may therefore provide different or the same data that is found in the beacons in order to expand the scenarios that the automatic configuration of conference features addresses and to provide the functionality to client devices that are unable to receive the beacons.

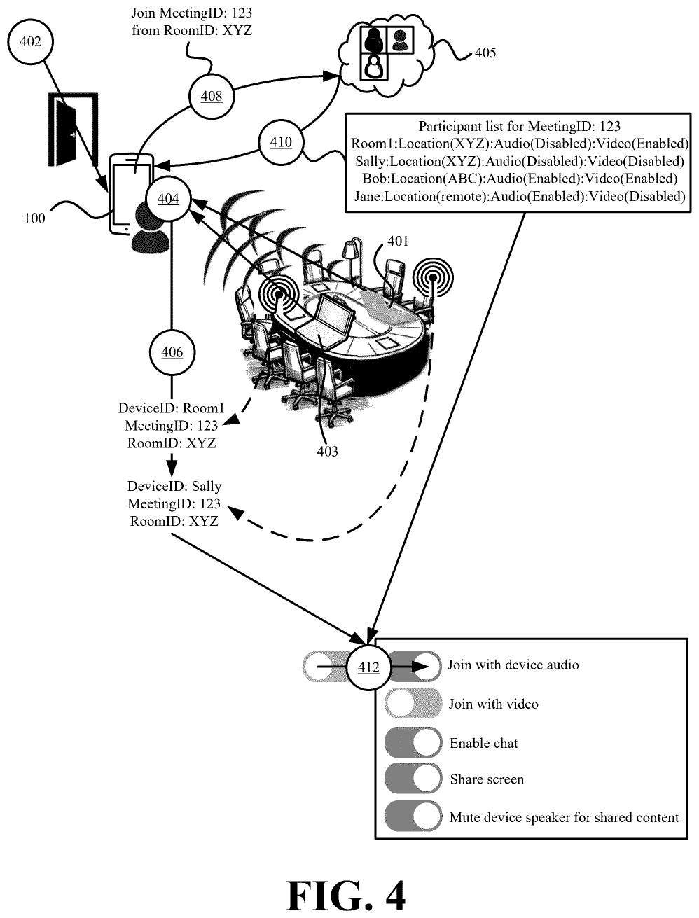

FIG. 4 illustrates an example of using the supplemental conference data to automatically configure conference devices in accordance with some embodiments presented herein. Client device 100 enters (at 402) into beaconing range of other devices 401 and 403. Client device 100 receives (at 404) the beacons broadcast by devices 401 and 403, and decodes (at 406) a first identifier that identifies each device 401 and 403 as having joined a particular conference and a second identifier that identifies the conference room or physical location of each device 401 and 403. Client device 100 may prompt its user to confirm whether client device 100 is in the conference room or physical location identified by the second identifier found in the beacons.

Client device 100 issues (at 408) a request to join the particular conference to conferencing system host device 405. The request may include the first identifier for the particular conference, the second identifier for the conference room or physical location, and/or identifying information for client device 100 or the associated user so that conferencing system host device 405 may authenticate client device 100 or the associated user for access to the particular conference.

Conferencing system host device 405 adds client device 100 to the particular conference and provides (at 410) the supplemental conference data to client device 100. The supplemental conference data may provide the status of each device or conference participant that has joined the particular conference. The status may correspond to the conference features that are enabled or disabled on each device. For instance, the supplemental conference data may indicate that devices 401 and 403 are connected to the particular conference with computer audio disabled. In other words, the microphones of devices 401 and 403 are disabled as devices 401 and 403 may be used for viewing presentation content rather than communicating with other conference participants.

Based on the provided (at 410) supplemental conference data, client device 100 determines that there is no potential for an echo created by a microphone of one device picking up speaker output of another device. Moreover, client device 100 determines that audio from the conference room is not being recorded and/or streamed to the other conference participants. Accordingly, client device 100 automatically configures (at 412) to join the particular conference with computer audio enabled. Client device 100 then captures sound for the conference room and/or users associated with client device 100 and devices 401 and 403, and generates an audio stream that is passed to conferencing system host device 405 for distribution to other devices that connect from other locations or rooms. Also, conferencing system host device 405 provides a unified audio stream to client device 100 for playback of the audio from the other devices in the other locations or rooms on the speaker of client device 100.

The automatic configuration of conference features may also address and/or preemptively resolve distractions and disruptions that are caused from the sharing of content by different devices in the same room or physical location. For instance, a client device and a conference device may be connected to the same conference from the same room. The client device microphone may be muted when the conference device microphone is used to capture the room audio. However, the user associated with the client device may share content that includes audio (e.g., video, presentation, sound clip, etc.). The content is sent to the conferencing system host device, and the conferencing system host device integrates the content audio in the conference audio stream such that the content audio is played from the conference device speaker. The content audio may also play from the client device speaker with a delay or offset relative to the playback of the content audio from the conference device. The dual playback of the content audio may feedback into the conference device microphone and create an echo and/or may make the content audio inaudible in the room.

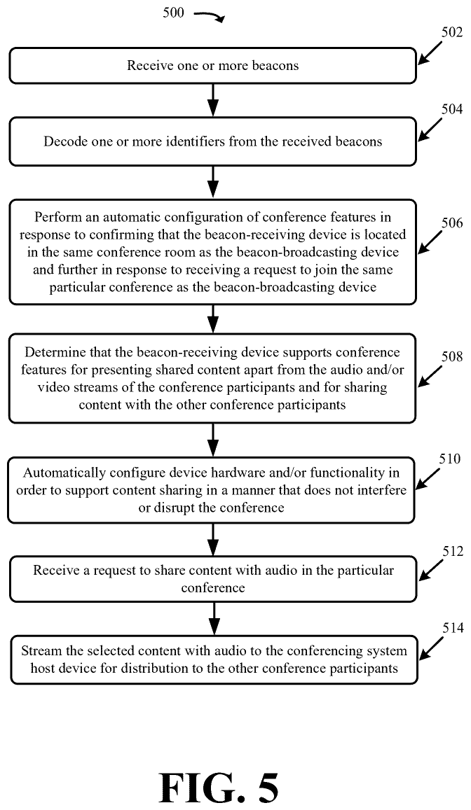

FIG. 5 presents a process 500 for automatically configuring conference features to resolve issued created when sharing content with multiple devices in the same room that are connected to the same conference in accordance with some embodiments presented herein. Process 500 is implemented by any device that connects to the conference.

Process 500 includes receiving (at 502) one or more beacons that are broadcast by at least one other device in proximity of the receiving (at 502) device. Process 500 includes decoding (at 504) one or more identifiers from the received (at 502) beacons. The one or more identifiers may indicate the particular conference that the beacon-broadcasting device has joined and the conference room or physical location in which the beacon-broadcasting is located.

Process 500 includes performing (at 506) an automatic configuration of conference features in response to confirming that the beacon-receiving device is located in the same conference room as the beacon-broadcasting device and further in response to receiving a request to join the same particular conference as the beacon-broadcasting device. Performing (at 506) the automatic configuration of conference features may include determining that the beacon-broadcasting device is the primary recording and playback device in the particular room, and disabling the beacon-receiving device from recording or playing back the conference audio. In some example embodiments, the disabling the recording or audio playback includes joining the conference without computer audio so that conference audio stream are not sent to or received by the beacon-receiving device.

Process 500 includes determining (at 508) that the beacon-receiving device supports conference features for presenting shared content apart from the audio and/or video streams of the conference participants and for sharing content with the other conference participants. Accordingly, process 500 includes automatically configuring (at 510) device hardware and/or functionality in order to support content sharing in a manner that does not interfere or disrupt the conference. Specifically, the device hardware and/or functionality is configured (at 510) to ensure that the sharing of content does not disrupt or interfere with the conference audio and/or video feeds. In some example embodiments, automatically configuring (at 510) the device hardware and/or functionality includes muting or turning the speaker volume of the beacon-receiving device to zero to avoid the audio from playback of the shared content from feeding back into the conference audio stream and/or being picked up by the microphone of another device in the same room. The adjustment of the speaker volume control is different than the control for the content playback volume. For instance, adjusting the speaker volume control does not mute or turn down the content playback volume control on the player or application that is used to present the shared content on the beacon-receiving device. As such, the content audio is still audible and/or not muted when uploaded from the beacon-receiving device to the conferencing system host device for integration in the conference audio stream. However, the playback of the shared content on the beacon-receiving device will result in no audio being output from the device speaker.

Process 500 includes receiving (at 512) a request to share content with audio in the particular conference. For instance, the user associated with the beacon-receiving device selects the share control of the particular conference and selects a file that is to be presented or played for all other conference participants.

Process 500 includes streaming (at 514) the selected content with audio to the conferencing system host device for distribution to the other conference participants. Streaming (at 514) the selected content may include playing the selected content on the sending beacon-receiving device and uploading the generated video and/or audio to the conferencing system host device. Since the automatic configuration (at 510) of the device hardware and/or functionality muted the speaker volume, the playback of the selected content does not result in audible sounds being generated from the device speaker. Instead, the selected content audio is played from the speaker of the beacon-broadcasting device or another device in the same conference room that is designated as the primary capture and playback device for the conference participants and/or devices in the conference room or that is identified in the supplemental conference data as having audio capture and/or playback enabled for the conference.

In some example embodiments, the automatic configuration of conference features involves generating a customized presentation of the conference based on the location of the presentation device relative to the location of the other devices participating in the same conference and the type or functionality enabled for the other devices. The customized presentation may include removing redundant or distracting video feeds of participants that are physically present in the same room as the viewer, bifurcating the presentation of the conference participants to a conference room device and the presentation of shared content to a personal client device, and/or simplifying the interface on the client device to enable different modalities for supplemental conference features that may be inaccessible from a shared conference room device or another user's device.

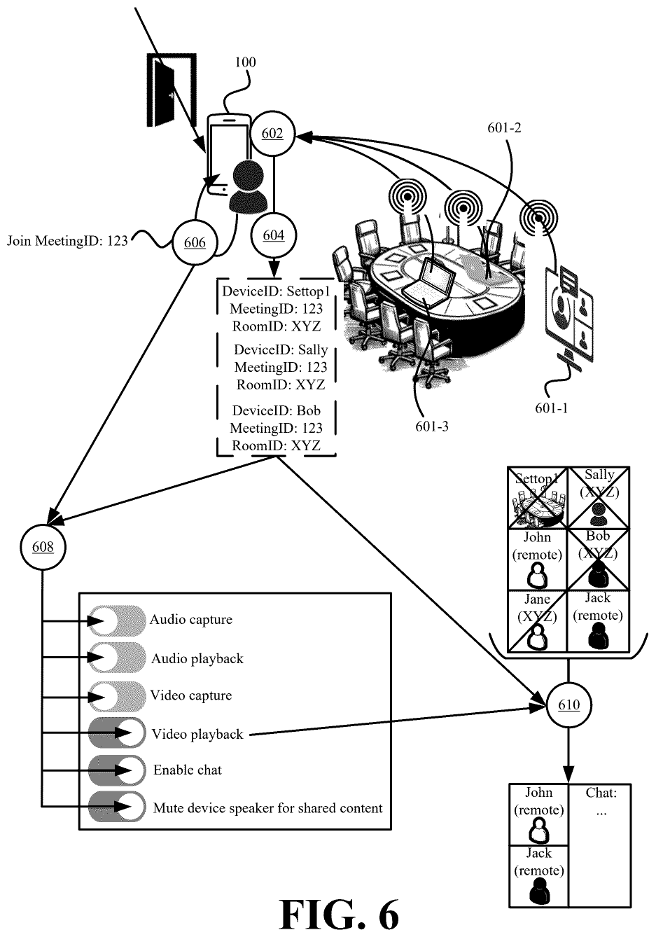

FIG. 6 illustrates an example of automatically configuring a customized conference presentation for a client device in accordance with some embodiments presented herein. Client device 100 receives (at 602) one or more beacons from one or more other devices 601-1, 601-2, and 601-3 that are located in common conference room. In some example embodiments, client device 100 may receive (at 602) the one or more beacons from a single conference device in the common conference room.

Client device 100 extracts (at 604) the conference and/or room identifiers from the received (at 602) beacons. The extracted (at 604) identifiers reveal that devices 601-1, 601-2, and 601-3 have joined the same conference from the common conference room.

Client device 100 receives (at 606) a request to join the same conference as identified in the one or more beacons with confirmation that client device 100 is located in the same common conference room as other devices 601-1, 601-2, and 601-3. In response to the join request, client device 100 may communicate with the conferencing system host device to obtain supplemental conference data. The supplemental conference data may identify the conference participants that are in the common conference room. For instance, the supplemental conference data may identify other devices 601-1, 601-2, and 601-3 that have joined the conference from the common conference room and/or the user associated with each device 601-1, 601-2, and 601-3 as well as devices that have joined the conference from different remote locations. Alternatively, the supplemental conference data may identify each user that has checked-in to the common conference room or has otherwise indicated their physical presence in the common conference room via one of other devices 601-1, 601-2, and 601-3. For instance, three users may check-in to the conference using device 601-1 and may participant in the conference using only device 601-1 without connecting individual client devices. The supplemental conference data may also specify the conference features that are enabled or disabled on other devices 601-1, 601-2, and 601-3.

Client device 100 automatically configures (at 608) the conference features to eliminate or minimize potential for echoes, disruptions, and distractions caused by multiple devices in the same room capturing and playing back audio. Additionally, client device 100 automatically configures (at 610) a customized conference presentation based on extracted beacon data and/or supplemental conference data.

Configuring (at 610) the customized conference presentation includes modifying the conference interface to minimize distractions caused by redundant or delayed video feeds of conference participants that are physically present in the same room as client device 100. For instance, client device 100 determines that the conference has 10 participants and 4 of the 10 participants are confirmed to be present in the same conference room as the user of client device 100. Client device 100 determines the video and/or audio feeds that are associated with the 4 participants that are in the conference room and/or their respective devices, and disables or removes those video and/or audio feeds from the interface. The removal of the video and/or audio feeds reduces the bandwidth requirement for a seamless conference. Moreover, the removal of the video feeds simplifies the interface by presenting the video feeds for only the remote participants so that the user of client device 100 is able to more easily determine when a remote participant is speaking or when a live participant in the conference room is speaking. The removal of the video feeds has the added benefit of removing a distraction that is caused when the video feed of a live participant in the conference room is presented with a delay relative to actual movements and speaking of the live participant in the conference room.

In some example embodiments, configuring (at 610) the customized conference presentation includes determining that a conference device in the conference room has a large display for presenting the video feeds of the remote participants. In some such example embodiments, client device 100 configures (at 610) the customized conference presentation to use the display of client device 100 as a supplemental communication or presentation interaction tool. For instance, in response to determining that the conference device in the conference room is presenting the audio and video feeds, client device 100 generates the conference interface with a chat or messaging interface with which the user of client device 100 may send text messages or other content to all connected devices or a selected subset of connected device associated with specific participants. Additionally, client device 100 presents content that another device or participant shares with or without tools by which the user of client device 100 may directly markup, edit, or comment on the shared content from client device 100. All comments made to the shared content by the various devices including client device 100 are consolidated in video feed of the shared content and presented to all other connected devices.

Although Bluetooth and Bluetooth beacons are widely supported across the different devices and device types used for conferencing, there may be some devices that have their Bluetooth radios off, that do not support Bluetooth beacons, or that otherwise are incompatible with the beaconing techniques described above for the automatic configuration of conference features. Accordingly, some example embodiments provide alternative means for determining device proximity and for performing the automatic configuration of conference features.

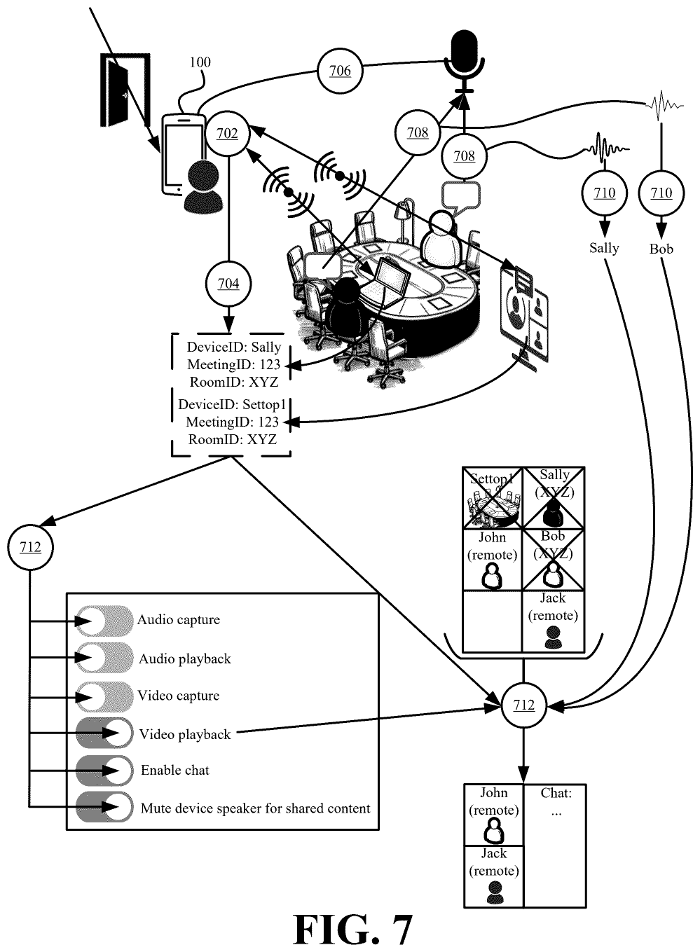

FIG. 7 illustrates an example of performing the automatic configuration of conference features based on proximity detection that is conducted without beacons in accordance with some embodiments presented herein. Client device 100 may not support the sending and/or receiving of Bluetooth beacons or may have its Bluetooth radio off or disabled when client device 100 enters into beacon signaling range of other conference devices that are located in a common conference room.

Client device 100 detects (at 702) the other conference devices that are in short-range proximity (e.g., less than 50 meters) using alternative short-range wireless signaling communication technologies. For instance, client device 100 may use Ultra-Wideband (UWB) or Near-Field Communication (NFC) to detect (at 702) one or more of the other conference devices.

In response to detecting (at 702) the other conference devices, client device 100 may establish a peer-to-peer or direct connection with a detected device, and query (at 704) the other conference devices for the identifiers of the beacon data. For instance, client device 100 may query the other conference devices for the identifier of a conference that each conference device is connected to and/or the identifier of the conference room that the conference device is located in. Accordingly, client device 100 may generate a list of nearby devices, the conferences they have joined, and/or the conference rooms in which they are located.

Client device 100 may separately confirm location and/or nearby conference participants based on voice signatures and/or audio matching. As client device 100 enters into a conference room when the conferencing application is running in the background or when the conferencing application is brought to the foreground and/or given key focus, client device 100 enable (at 706) its microphone to begin capturing (at 708) sounds.

Client device 100 analyzes the captured audio, and in response to detecting a human voice, client device 100 performs (at 710) a voice matching to determine the user associated with that voice. In some example embodiments, client device 100 may store voice signatures for different conference participants or different users in an organization or enterprise. In some other example embodiments, client device 100 may receive the voice signatures as the supplemental conference data from the conferencing system host device. For instance, the user associated with client device 100 may open the conferencing application and perform an action to join a particular conference. Client device 100 sends a join request to the conferencing system host device, and the conferencing system host device may add client device 100 to the conference and provide voice signatures and/or locations for other participants that have already joined the same conference.

Client device 100 automatically configures (at 712) the conference features based on the other devices and/or users that are detected to be in the same conference room as client device 100 and that have joined the same conference as client device 100. Client device 100 may automatically configure (at 712) the conference features according to the conference features that are enabled or disabled on the other conference devices or based solely on the detected presence of the other conference devices. For instance, client device 100 may determine that one of the other conference devices has the audio and video streams enabled. Accordingly, client device 100 may disable its own audio and video streams in order to avoid introducing an echo and may customize the conference presentation to present a chat interface, video or images of shared content without audio, and/or video feeds of remote participants that are not detected to be in physical proximity with client device 100 with video feeds of users in the same room disabled based on the alternative short-range wireless signaling communication detection and/or voice signature matching.

The embodiments presented above are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the above descriptions are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (“IoT”) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (“RAM”), read only memory (“ROM”), electrically erasable programmable ROM (“EEPROM”), flash memory, or other memory technology, compact disk ROM (“CD-ROM”), digital versatile disks (“DVDs”) or other optical storage, solid state drives, hard drives, hybrid drive, or any other medium that can be used to store the desired information and that can be accessed to retrieve that information.

It is appreciated that the presented systems and methods can be implemented in a variety of architectures and configurations. For example, the systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

It should be understood, that terms “user” and “participant” have equal meaning in the following description.

1. A computer-implemented method for automatically configuring conference features, the computer-implemented method comprising:
receiving, at a first device, one or more identifiers indicating a conference that a second device has joined from a particular location;
receiving, at the first device, a request to join the conference with the first device at the particular location; and
configuring the conference features in response to the request to join the conference that the second device has joined from the particular location, wherein configuring the conference features comprises modifying a conference feature on the first device to not conflict with the conference feature on the second device.

2. The computer-implemented method of claim 1, further comprising:
verifying that the first device is at the particular location in response to receiving the one or more identifiers from the second device using a short-range wireless technology.

3. The computer-implemented method of claim 1, further comprising:
receiving a plurality of beacons over a short-range wireless technology;
decoding the particular location and zero or more other locations from the plurality of beacons;
presenting, in a selectable interface, the particular location and zero or more other locations, that are decoded from the plurality of beacons; and
determining that the first device is at the particular location in response to a user selection of the particular location from the selectable interface.

4. The computer-implemented method of claim 1, further comprising:
joining the conference with one or more of the conference features enabled and other conference features disabled as a result of said configuring.

5. The computer-implemented method of claim 1, further comprising:
joining the conference without computer audio in response to configuring the conference features.

6. The computer-implemented method of claim 1, further comprising:
determining that the second device has enabled conference features for recording and playing back conference audio; and
joining the conference with the conference features for recording and playing back conference audio disabled on the first device in response to configuring the conference features and determining that the second device has enabled the conference features for recording and playback back conference audio.

7. The computer-implemented method of claim 1, further comprising:
presenting a user interface comprising settings for disabling and enabling different conference features, wherein the settings are generated from configuring the conference features.

8. The computer-implemented method of claim 1, further comprising:
detecting a particular conference feature that is enabled on the second device; and
wherein configuring the conference features comprises:
determining that enabling the particular conference feature on the first device creates one or more of an echo, disruption, or distraction in the conference; and
automatically disabling the particular conference feature on the first device without user inputs.

9. The computer-implemented method of claim 1, further comprising:
generating a customized presentation of the conference on the first device in response to the request to join the conference with the first device at the particular location and the second device having also joined the conference from the particular location, wherein generating the customized presentation comprises:
removing a video stream capturing a user of the second device from the customized presentation; and
presenting a video stream of another user that joins the conference from a location other than the particular location.

10. The computer-implemented method of claim 1, further comprising:
generating a customized presentation of the conference on the first device in response to the request to join the conference with the first device at the particular location and the second device having also joined the conference from the particular location, wherein generating the customized presentation comprises:
determining that the second device presents participant video and audio for users at the particular location; and
presenting one or more of a chat interface or content that is shared during the conference on the first device in place of the participant video.

11. The computer-implemented method of claim 1, further comprising:
receiving a request to share content from the first device with other participants of the conference;
automatically configuring volume for a speaker of the first device without adjusting a configured playback volume for the content;
playing the content on the first device with sound from the speaker disabled; and
streaming the content playing on the first device at the configured playback volume to the other participants of the conference.

12. A first device for automatically configuring conference features, the first device comprising:
one or more hardware processors configured to:
receive one or more identifiers indicating a conference that a second device has joined from a particular location;
receive a request to join the conference with the first device at the particular location; and
configure the conference features in response to the request to join the conference that the second device has joined from the particular location, wherein configuring the conference features comprises modifying a conference feature on the first device to not conflict with the conference feature on the second device.

13. The first device of claim 12, wherein the one or more hardware processors are further configured to:
verify that the first device is at the particular location in response to receiving the one or more identifiers from the second device using a short-range wireless technology.

14. The first device of claim 12, wherein the one or more hardware processors are further configured to:
receive a plurality of beacons over a short-range wireless technology;
decode the particular location and zero or more other locations from the plurality of beacons;
present, in a selectable interface, the particular location and zero or more other locations, that are decoded from the plurality of beacons; and
determine that the first device is at the particular location in response to a user selection of the particular location from the selectable interface.

15. The first device of claim 12, wherein the one or more hardware processors are further configured to:
join the conference with one or more of the conference features enabled and other conference features disabled as a result of said configuring.

16. The first device of claim 12, wherein the one or more hardware processors are further configured to:
join the conference without computer audio in response to configuring the conference features.

17. The first device of claim 12, wherein the one or more hardware processors are further configured to:
determine that the second device has enabled conference features for recording and playing back conference audio; and
join the conference with the conference features for recording and playing back conference audio disabled on the first device in response to configuring the conference features and determining that the second device has enabled the conference features for recording and playback back conference audio.

18. The first device of claim 12, wherein the one or more hardware processors are further configured to:
present a user interface comprising settings for disabling and enabling different conference features, wherein the settings are generated from configuring the conference features.

19. The first device of claim 12, wherein the one or more hardware processors are further configured to:
detect a particular conference feature that is enabled on the second device; and
wherein configuring the conference features comprises:
determine that enabling the particular conference feature on the first device creates one or more of an echo, disruption, or distraction in the conference; and
automatically disable the particular conference feature on the first device without user inputs.

20. A non-transitory computer-readable medium storing program instructions that, when executed by one or more hardware processors of a first device, cause the first device to perform operations comprising:
receiving one or more identifiers indicating a conference that a second device has joined from a particular location;
receiving a request to join the conference with the first device at the particular location; and
configuring conference features in response to the request to join the conference that the second device has joined from the particular location, wherein configuring the conference features comprises modifying a conference feature on the first device to not conflict with the conference feature on the second device.
